(19) United States
(12) Patent Application Publication
(10) Pub. No.: US 2010/0314092 A1
(43) Pub. Date: Dec. 16, 2010

(54) HEAT TRANSFER TUBE

(75) Inventors: Jorg Kirchner, Lipprechterode (DE); Carlo Balli, Loc. La Palazzina (IT); Ignacio Catalan, Tauste (ES)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6731, US

(73) Assignee: Bundy Refreigeration GmbH

(21) Appl. No.: 12/744,854

(22) PCT Filed: Nov. 28, 2008
(86) PCT No.: PCT/IB2008/003269

§ 371 Date: Aug. 31, 2010

(30) Foreign Application Priority Data
Nov. 30, 2007 (DE) 20 2007 016 841.1

(51) Int. Cl. F28F 1/16; B23P 15/26

(52) U.S. Cl. 165/183; 165/181; 29/890.045

(57) ABSTRACT

A heat transfer tube (101) for a heat exchanger. The wall (120) of the heat transfer tube comprising at least one axially extending wing-shaped protrusion (104, 105) to provide the tube with additional heat transfer surface area. The wing shaped protrusion is formed by a process comprising at least one of: (i) folding the wall of the tube; and (ii) extrusion.

### CROSS REFERENCE TO RELATED APPLICATIONS

This application claims priority from German Gebrauchsmuster Application No. 20 2007 016 841.1, filed 30 Nov. 2007, the whole contents of which are incorporated herein by reference in their entirety.

### BACKGROUND OF THE INVENTION

1. Field of the Invention

The present invention relates to a heat transfer tube for a heat exchanger, a heat exchanger formed of the heat transfer tube and a method of manufacturing a heat transfer tube.

2. Description of the Related Art

Heat transfer tubes for evaporators or condensers of heating and cooling units are, for example, used for the evaporation and liquefaction of a cooling agent in refrigerators or air conditioners in vehicle engineering and also for general heat transfer. These heat transfer tubes consist, as generally known, of one tube with a smooth surface. In general a first fluid passes through the tube and heat is transferred through the walls of the tube between the fluid within and a fluid surrounding the tube. Each of the fluids may be either a gas or liquid. For example, in the case of a refrigeration unit, the heat transfer tube contains a cold liquid that evaporates into its gas phase, whereby heat passes from the air surrounding the tube to the liquid within the tube. Whereas, in a related condenser relatively warm liquid loses its heat through the tube to the relatively cool air surrounding the tube.

To increase the heat transfer surface of the tubes, and thus increase the heat transfer coefficient, the tubes are provided with additional heat conducting material that is in metallic contact with the tube or that is connected with the tube by soldering or welding. This additional heat exchange material, according to normal technical standards, is in the form of lamellas of thin plate that are located on the tube at specific positions and angles. Alternatively this additional heat exchange material may be fins extending at various angles around the tube, or alternatively may be wires that are welded to the tube.

A problem with the production of heat exchangers formed in such a manner, with this additional heat conductive material, is that it is very material and cost intensive.

A second problem is that the additional heat conducting materials used to create heat transfer surfaces are not all equally used in the heat transfer process. This leads to a decrease of a heat transfer coefficient.

There is also a risk, especially for evaporators in which the heat transfer tube is formed of steel and painted for corrosion protection, that the painted layer will crack where the tube is contacted to the additional heat conductive material. Consequently, corrosion is not avoidable where the cracking occurs.

German patent publication DE 101 07 653 A1 mentions a heat transfer tube in which cooling lamellas are produced by a non-cutting forming of the wall of a tube, like a thread rolling process. However, the method produces only a very small increase of the heat transferring surface and so it has little effect on the heat transfer of the tube.

### BRIEF SUMMARY OF THE INVENTION

According to a first aspect of the present invention, there is provided a heat transfer tube as claimed in claim 1.

Test measurements on a heat transfer tube in accordance with the invention showed that a heat transfer coefficient can be achieved that is higher than those of the above mentioned conventional evaporators and condensers.

For the heat transfer tube in accordance with the present invention, the heat transfer was roughly equal over the entire surface of the heat transfer tube.

In addition, because the wing-shaped protrusion is formed out of the tube material, differentials in the elongation of material caused by temperature variations are avoided. Consequently, paint cracks in a painted heat transfer tube can be completely avoided, and therefore the risk of corrosion can also be avoided.

In a preferred embodiment of the present invention, the tube extends along a centre line and the wing-shaped protrusion is formed into a twisting shape extending about the centre line. Preferably the wing-shaped protrusion forms a spiral around the centre line of the tube. In an alternative preferred embodiment the wing-shaped protrusion forms a wave shape along the tube. With a wing-shaped protrusion formed into such twisting shapes, the heat transfer through the wing-shaped protrusion can be further improved by the increased airflow. Due to this, the heat transfer coefficient will be further improved.

In one embodiment the heat transfer tube includes two straight portions separated by a curved portion extending around an axis defined by the curvature of the curved portion, and a portion of the wing-shaped protrusion extending along the curved portion extends parallel to the axis.

In a preferred embodiment of the present invention, the heat transfer tube is formed into a shape having at least two axially extending wing-shaped protrusions, and the wing-shaped protrusions are equally spaced around the wall of the tube. By this means, the total heat transfer surface can be fundamentally increased and the heat transfer can be more evenly distributed.

In some embodiments, the wing-shaped protrusion of the tube is pressed such that two different portions of the inside surface of the tube are in contact with each other. Thus, no gap exists between these two different portions. Such an arrangement provides the tube with increased mechanical rigidity, which is particularly useful for tubes with smaller wall thicknesses.

In other embodiments of the present invention the heat transfer tube has a main flow portion defining a main bore and the wing-shaped protrusion defines a gap that is open to the main bore. In this way, fluid flowing down the bore of the tube is able to pass into and out of the gap, so that heat transfer is further improved.

In some embodiments of the present invention, the heat transfer tube is formed into a meandrous shape, or formed into a flat meandrous shape that is folded into a package. Such arrangements are suitable for use as an evaporator or condenser.

Depending on the purpose of use, the heat transfer tube is formed from a material selected from the group: steel; steel alloy; copper; copper alloy; aluminium; and aluminium alloy.

According to a second aspect of the present invention, there is provided a method of manufacturing a heat transfer tube as claimed in claim 15.

According to a third aspect of the present invention, there is provided a method of manufacturing a heat transfer tube as claimed in claim 16.

### BRIEF DESCRIPTION OF THE SEVERAL VIEWS OF THE DRAWINGS

FIG. 1 shows a heat transfer tube 101 embodying the present invention;

FIG. 2 illustrates a first method for the production of heat transfer tube 101;

FIG. 3 illustrates an alternative method of manufacturing heat transfer tube 101;

FIG. 4 shows an alternative heat transfer tube 401 embodying the present invention;

FIG. 5 shows a condenser 501 for use in a refrigeration unit;

FIG. 6 shows a partial cross-sectional view of the bracket 504, the heat transfer tube 101a and the cylindrical tube 502a shown in FIG. 5;

FIG. 7 shows a further alternative heat transfer tube 701;

FIG. 8 shows yet a further alternative heat transfer tube 801;

FIG. 9 shows a further alternative heat transfer tube 901;

FIG. 10 shows yet a further alternative heat transfer tube 1001;

FIG. 11 shows a tube formed into a flat meandrous shape suitable for folding to form a package;

FIG. 12 shows the heat transfer tube 1104 of FIG. 11 folded up to form a package;

FIG. 13 shows a heat transfer tube that has a single wing-shaped protrusion 1304 extending from its main flow portion 1302; and

FIG. 14 shows three more heat transfer tubes 1401, 1441 and 1471 for use in heat exchangers.

### DETAILED DESCRIPTION OF THE PREFERRED EMBODIMENTS

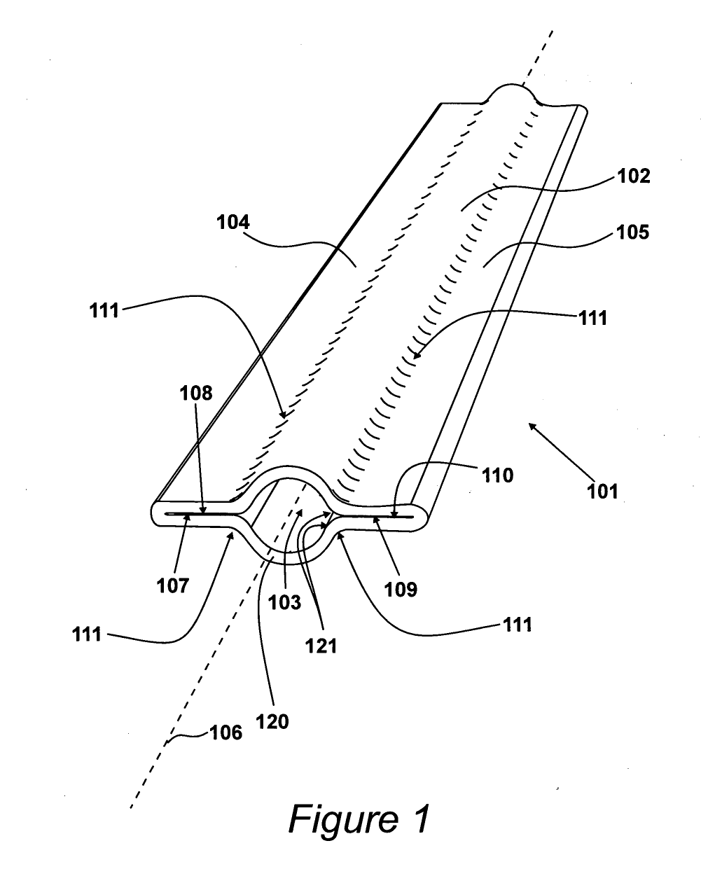

### FIG. 1

A heat transfer tube 101 embodying the present invention is shown in FIG. 1. The tube 101 has a central main flow portion 102 defining a main bore 103. A first wing-shaped protrusion 104 extends from one side of the main flow portion 102 and a second wing-shaped protrusion 105 extends from the opposite side of the main flow portion 102. Thus, the two wing-shaped protrusions 104 and 105 are symmetrically arranged around a centre line (or axis) 106 of the tube. As may be observed from FIG. 1, as well as extending away from the main flow portion 102, each of the wing-shaped protrusions extend axially along the tube 101. That is, they extend along the tube parallel to the axis 106.

As will be explained in further detail below, the tube 101 is formed by deforming a length of cylindrical tubing. More specifically, the wall 120 of the tube is folded into the shape shown in FIG. 1. In the present case, the material of the tube has been deformed such that a portion 107 of the inside surface of the tube 101 has been pressed into contact with a different portion 108 of the inside surface of the tube. Consequently, the first wing-shaped protrusion 104 has been formed without a gap between the portions 107 and 108 of the inside surface of the tube. Similarly, a portion 109 of the inside surface of the tube has been pressed into contact with a different portion 110 of the inside surface of the tube. Consequently, the second wing-shaped protrusion has been formed without a gap between the portions 109 and 110 of its inside surface.

The main flow portion 102 of the tube 101 has an almost cylindrical shape, except where it adjoins the wing-shaped protrusions. Thus, the main flow portion 102 has a convex curved outer surface, and the outer surface of the tube has axially extending concave grooves 111 defining the boundary between the main flow portion and the wing-shaped protrusions. Similarly, because the tube has been formed by folding the wall 120, the main flow portion 102 has a concave curved inner surface, and the inner surface of the tube has axially extending convex ridges 121 along the boundary between the wing-shaped protrusions 104 and 105 and the main flow portion.

The wing-shaped protrusions 104 and 105 have substantially flat faces. However, as will be described further below, a tube such as tube 101 may be further processed such that the wing-shaped protrusions have a more complex profile.

The tube 101 is intended for use as, or as part of, a heat exchanger. Consequently, during use of tube 101, a first fluid is passed through the bore of the tube while a second fluid surrounds the outside of the tube. Depending upon the relative temperatures of the two fluids, heat flows from the first (or second fluid) to the other fluid via the wall of the tube. As the wing-shaped protrusions 104 and 105 are formed of the same material as the main flow portion 102, the wing-shaped protrusions increase the heat transfer surface area of the tube and provide improved heat transfer.

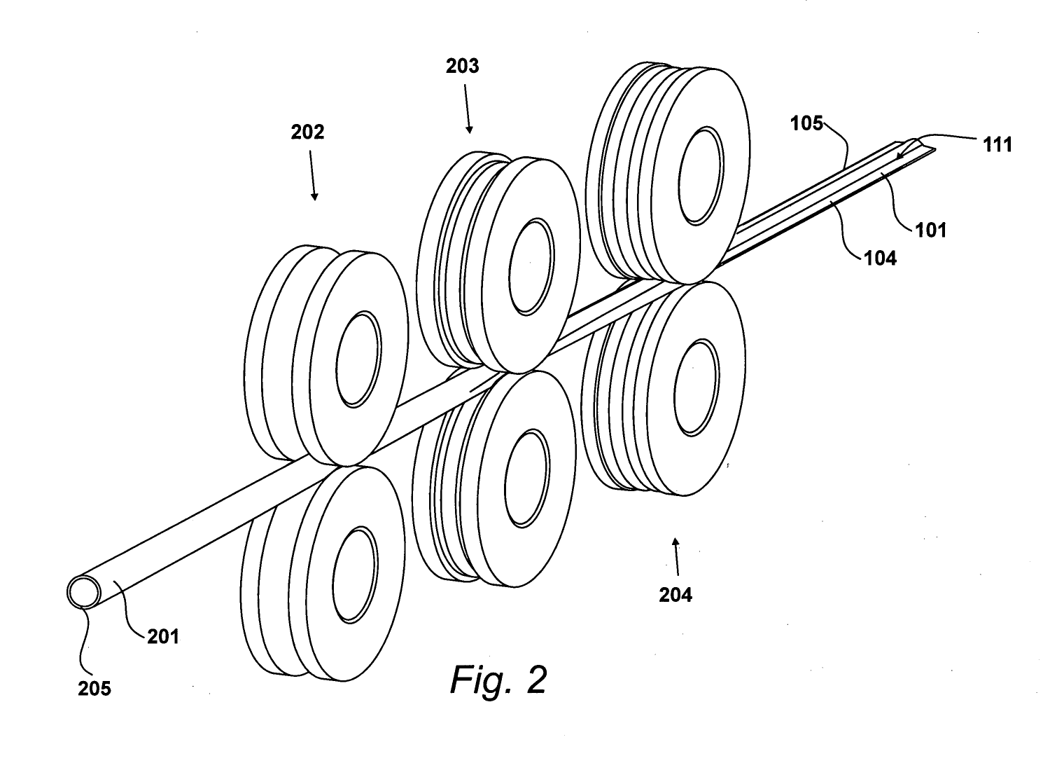

### FIG. 2

A first method for the production of heat transfer tube 101 is illustrated in FIG. 2. The method comprises obtaining cylindrical tubing 201 and passing the tubing through a series of rollers in a rolling mill. Thus, as shown in FIG. 2, cylindrical tubing 201 is passed between three pairs of rollers 202, 203, and 204. Each of the pairs of rollers 202, 203, 204 is designed to incrementally deform the wall 205 of the tube by pressing. Therefore, the first pair of rollers 202 exert forces on the tube 201 to cause it to become slightly oval. The second pair of rollers 203 then start folding the wall of the tube to produce the axially extending concave grooves in the tubing, which define the wing-shaped protrusions. The third pair of rollers 204 then further deform the wall of the tube to deepen the concave grooves 111 and complete the definition of the wing-shaped protrusions 104 and 105. Thus the tube assumes its finished shape 101.

It will be understood that the bore of the finished tube 101 has a substantially smaller cross-sectional area than the bore of the cylindrical tube 201, due to the wall of the tube 201 being folded inwards on itself. In addition, because the wall 205 of the tube 201 is folded its thickness remains substantially unchanged during the forming process.

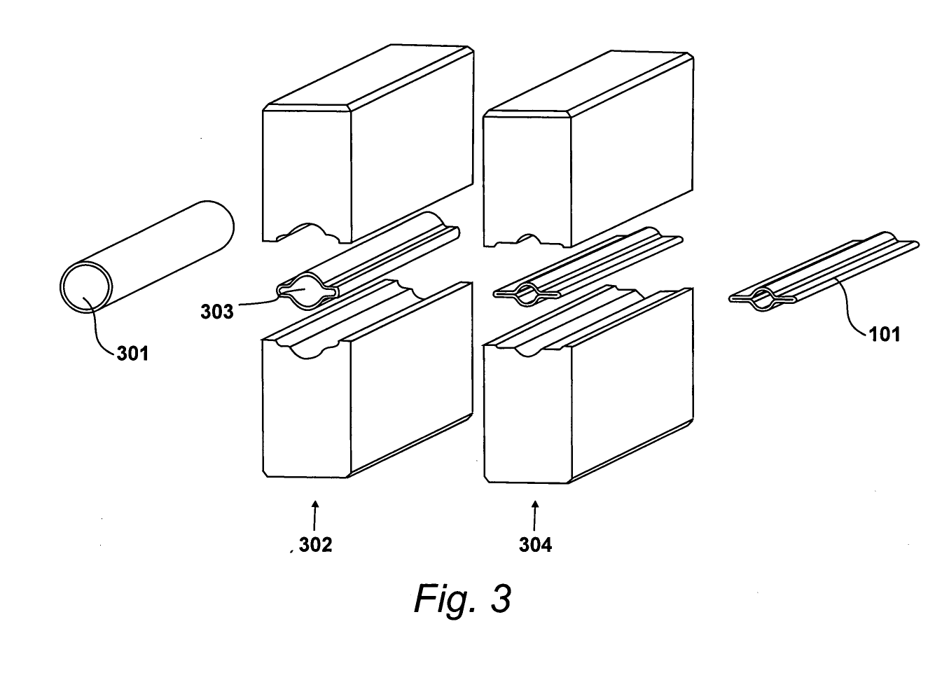

### FIG. 3

An alternative method of manufacturing heat transfer tube 101 is illustrated in FIG. 3. In this method, cylindrical tubing is cut to lengths 301 of the required size. The lengths of tubing 301 are then pressed in a first press 302. This first press folds the wall of the tube to form an intermediate stage tube 303 having relatively shallow axially extending grooves and wing-shaped protrusions that contain a large gap. The intermediate stage 303 is then further processed by pressing in a second press 304 to deepen the axially extending grooves and form the finished tube 101.

The methods illustrated by FIGS. 2 and 3 may be used to form tubes made of various metals or alloys, including: steel; steel alloy; copper; copper alloy; aluminium; and aluminium alloy.

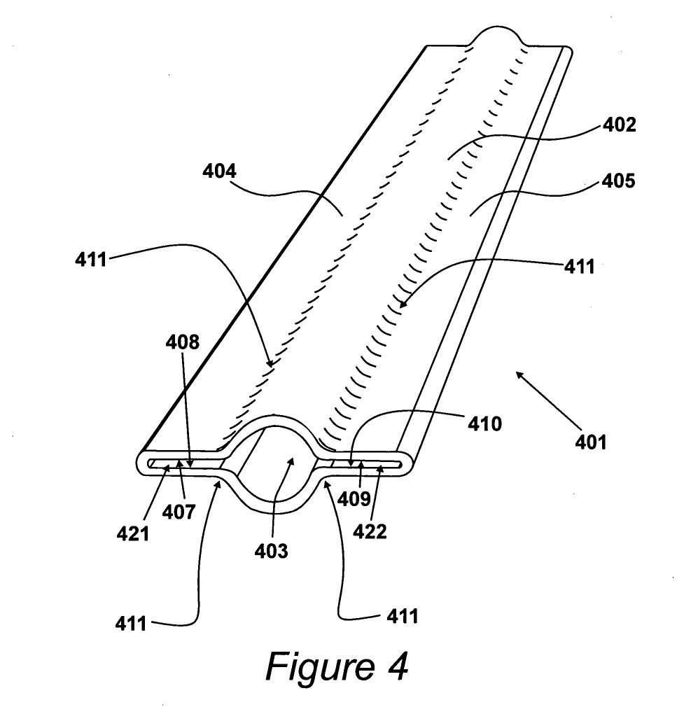

### FIG. 4

An alternative heat transfer tube 401 embodying the present invention is shown in FIG. 4. The tube 401 is similar to tube 101 in that it has a central main flow portion 402 defining a main bore 403, a first wing-shaped protrusion 404 extending from one side of the main flow portion 402 and a second wing-shaped protrusion 405 extending from the opposite side of the main flow portion 402.

The wing-shaped protrusions 404 and 405 may be formed using one of the methods described with respect to FIG. 2 or FIG. 3. However, the press tools are designed such that a gap is left between opposing portions of the inside surface of the tube 401. Thus, the wing-shaped protrusion 404 contains a gap 421 between the inside surfaces of said wing-shaped protrusion. Similarly, wing-shaped protrusion 405 contains a gap 422 between its inside surfaces. The gaps 421 and 422 are open to (that is they are in communication with) the main bore 403.

It may be noted that, like tube 101, tube 401 has four axially extending concave grooves 411 defining the boundaries between the convex surfaces of the main flow portion 402 and the wing-shaped protrusions 404 and 405.

During use of tube 401, a first fluid is passed through the bore of the tube while a second fluid surrounds the outside of the tube. Depending upon the relative temperatures of the two fluids, heat flows from the first (or second fluid) to the other fluid via the wall of the tube. Advantageously, fluid flowing down the bore of the tube is able to flow from the main bore 403 into the gaps 421 and 422 and also from the gaps to the main bore. This flow of fluid assists the even transfer of heat between the fluid in the bore of the tube and the fluid surrounding the tube.

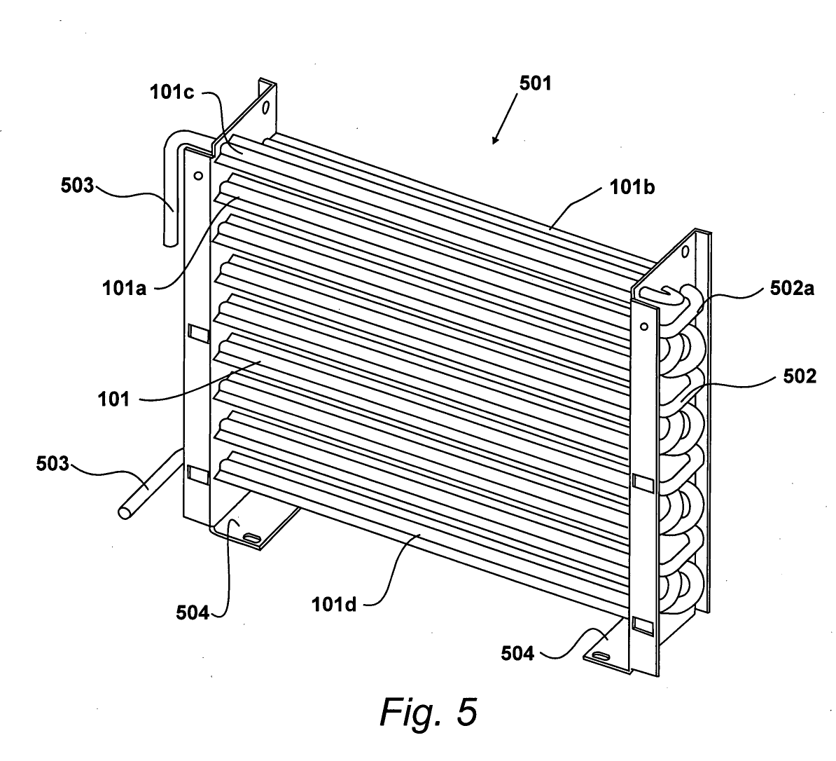

### FIG. 5

A condenser 501 for use in a refrigeration unit is shown in FIG. 5. The condenser 501 is formed from twenty-six heat transfer tubes 101 of the type illustrated in FIG. 1. Pairs of the heat transfer tubes 101 are connected by a relatively short length of cylindrical tubing 502; the cylindrical tubing being formed with a 180° bend so that the heat transfer tubes may be arranged substantially parallel to one another. Thus, for example, heat transfer tube 101a is connected to heat transfer tube 101b by a piece of cylindrical tubing 502a. In this manner, the heat transfer tubes 101 and cylindrical tubes 502 are connected together to form a continuous flow path for refrigerant. A heat transfer tube 101c and 101d at either end of the flow path is connected at its free end to an open ended length of cylindrical tubing 503 to provide connections to the remainder of the refrigeration circuit. As illustrated in FIG. 5, the cylindrical tubes 502 and the heat transfer tubes 101 are supported at either end of the heat transfer tubes 101 by a pair of brackets 504. The brackets 504, heat transfer tubes 101 and the cylindrical tubes 502 are brazed together using known techniques for manufacturing similar such types of condensers.

It may be noted that the condenser 501 is configured for use as a forced draft condenser, and, as such, it is provided with a blower (not shown) which forces air around the outer surfaces of the heat transfer tubes 101.

Although the condenser 501 makes use of heat transfer tubes 101, it should be understood that a similar condenser may be formed using heat transfer tubes of the type shown in FIG. 4.

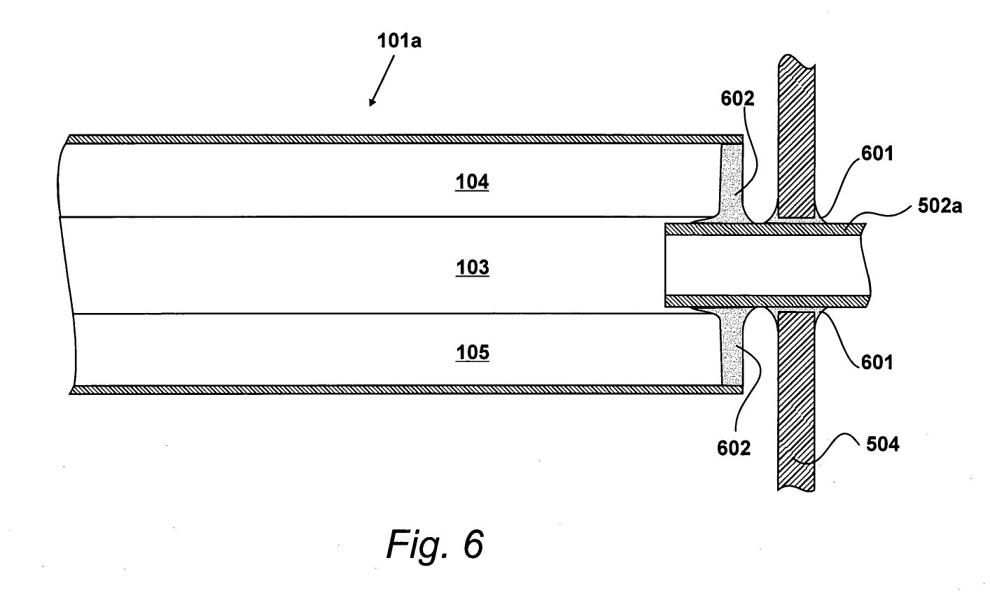

### FIG. 6

A partial cross-sectional view of bracket 504, heat transfer tube 101a and cylindrical tube 502a is shown in FIG. 6. As shown in FIG. 6, the end of cylindrical tubing 502a is fixed within an aperture defined by bracket 504 by braze alloy 601. Similarly, an end of heat transfer tube 101a is rigidly connected to the end of tube 502a by braze alloy 602. It may be noted that the braze alloy 602 at least partially extends into the wing-shaped protrusions 104 and 105 to ensure that the connection between tubes 101a and 502a is completely sealed.

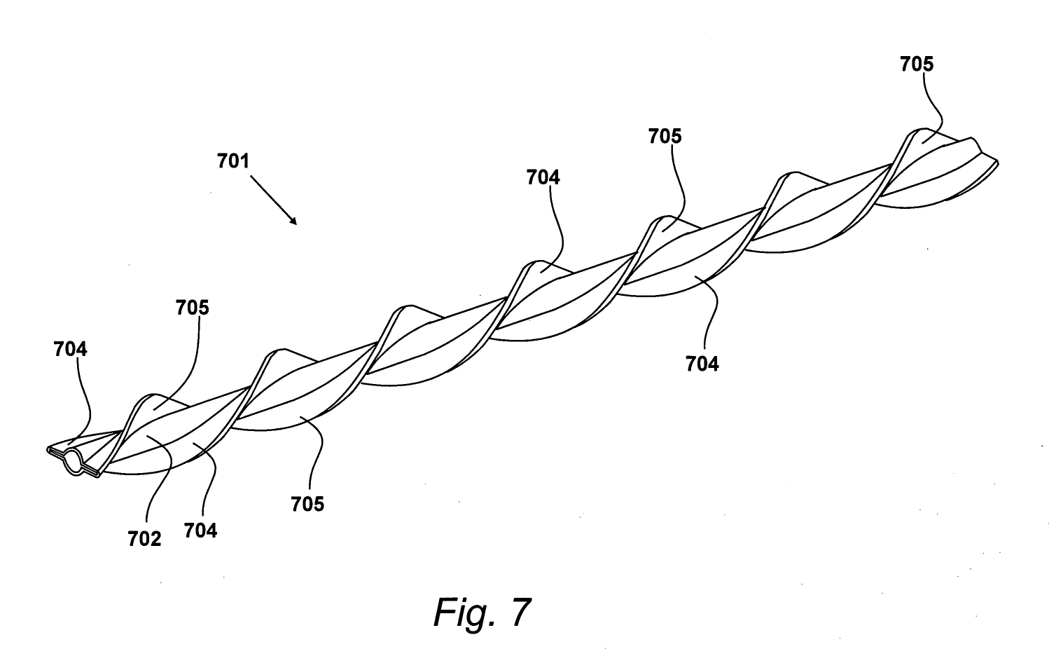

### FIG. 7

A further alternative heat transfer tube 701 is shown in FIG. 7. The heat transfer tube 701 is essentially the same as heat transfer tube 101 but, whereas tube 101 had substantially planar wing-shaped protrusions 104 and 105, the wing-shaped protrusions 704 and 705 of tube 701 form spirals about the main flow portion 702. More specifically, the edges of the wing-shaped protrusions form a double helix about the main flow portion 102.

The heat transfer tube 701 may be formed from heat transfer tube 101. This is done by clamping tube 101 at two spaced locations and then rotating one clamp with respect to the other about the tube's axis, thereby twisting the tube to form the spirals.

In an alternative heat exchanger to that shown in FIG. 5, the heat transfer tubes 101 are replaced by heat transfer tubes 701 as illustrated in FIG. 7.

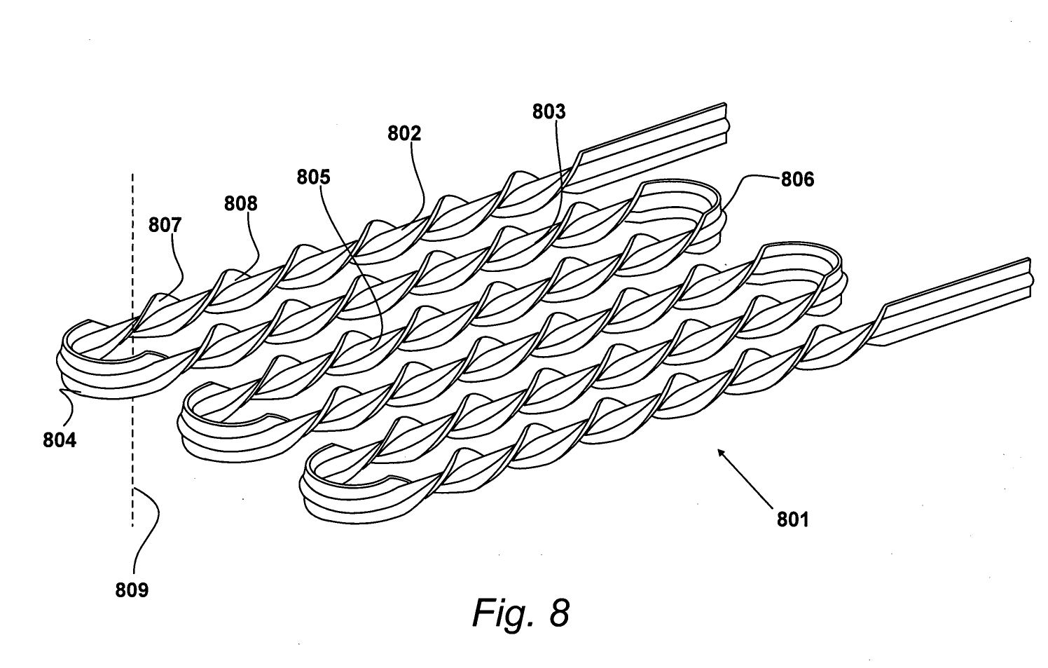

### FIG. 8

A further alternative heat transfer tube 801 is shown in FIG. 8. The heat transfer tube comprises six substantially straight parallel portions connected by 180° bends. Thus, for example, a first straight portion 802 is connected to a second straight portion 803 by a bend 804, and second straight portion 803 is connected to a third straight portion 805 by a second bend 806. In this way, the tube 801 is made to lie in a flat meandrous form.

The tube 801 may be used as a heat exchanger, such as an evaporator or condenser within a refrigeration unit.

It may be noted that the majority of the straight portions, such as 802, 803 and 805 have been twisted such that the wing-shaped protrusions 807 and 808 have been formed into a helix, like those of wing-shaped protrusions 705 and 704 of heat transfer tube 701. However, a portion of the wing-shaped protrusions extending around the 180° bends is not formed into a spiral shape but instead extends parallel to an axis at the centre of curvature of the 180° bend. Thus for example the wing-shaped protrusions 807 and 808 extend parallel to an axis 809 at the centre of curvature of the bend 804.

Like the previously described tubes, tube 801 is formed from cylindrical tubing. The cylindrical tubing is passed through rollers of a rolling mill such as those shown in FIG. 2 in order to produce a tube having the form of tube 101. This tube is then clamped at spaced positions and twisted to produce the straight spiral portions such as portions 802, 803 and 805. Non-twisted portions between these twisted portions are then bent to produce the 180° bends such as bend 804 and 806.

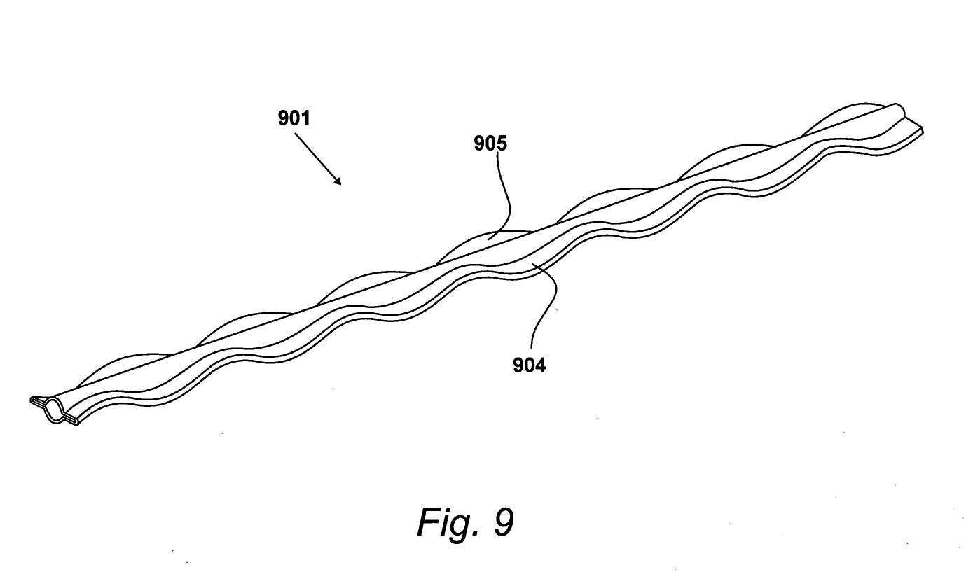

### FIG. 9

A further alternative heat transfer tube 901 is shown in FIG. 9. The heat transfer tube 901 is essentially the same as heat transfer tube 101, but unlike tube 101 its wing-shaped protrusions 904 and 905 have been formed into wave shapes. A tube such as tube 901 may be produced with such a wave shape using appropriately shaped press tools rather than those of FIG. 2.

In an alternative heat exchanger to that of FIG. 5, the heat transfer tubes 101 are substituted by heat transfer tubes such as the one illustrated in FIG. 9.

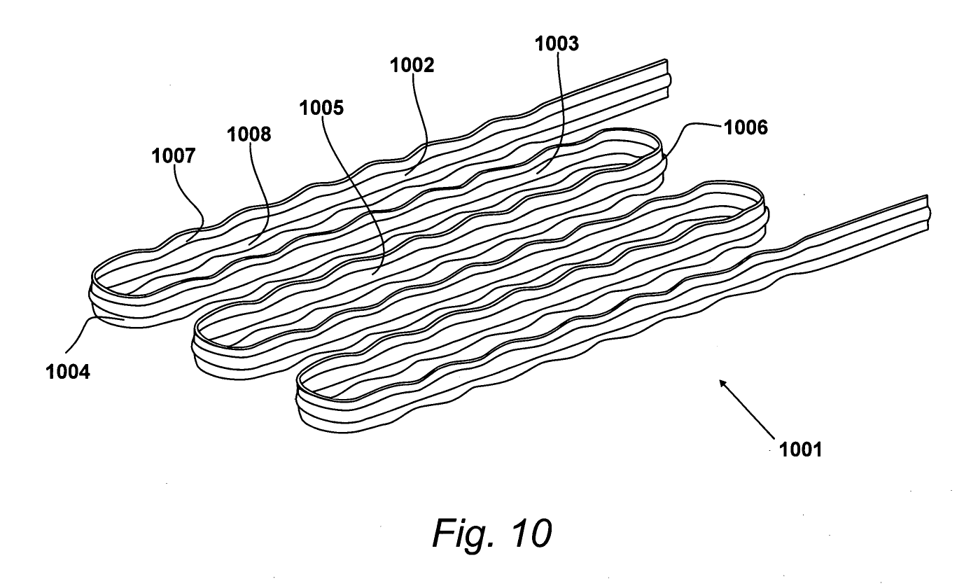

### FIG. 10

A further alternative heat transfer tube 1001 is shown in FIG. 10. The heat transfer tube 1001 has six substantially straight portions connected by 180° bends to produce a flat meandrous shape. For example a first straight portion 1002 is connected to a straight second straight portion 1003 by a first bend 1004, and the second straight portion 1003 is connected to a third straight portion 1005 by a second 180° bend 1006. A major part of the straight portions have been deformed in a press similar to that used to produce the tube 901, and consequently the wing-shaped protrusions 1007 and 1008 are formed into wave shapes. However, portions of the wing-shaped protrusions extending around the bends 1004 and 1006 have not been deformed in this way, in order to simplify formation of the bends.

Like the previously described heat transfer tubes, heat transfer tube 1001 is formed from a cylindrical tube. The cylindrical tube is firstly deformed in a rolling mill, such as that described with respect to FIG. 2, to produce a tube of a similar cross-section to that of FIG. 1. Portions of the tube corresponding to the straight portions such as 1002, 1003 and 1005 are then further processed to provide the wing-shaped protrusions with a wave shape. This may be achieved using suitably shaped press tools. The tube is then bent into the flat meandrous shape shown in FIG. 10, by forming the 180° bends such as bend 1004 and 1006.

The heat transfer tube 1001 may itself be used as a heat exchanger, for example it may be used as an evaporator or condenser in a refrigeration unit.

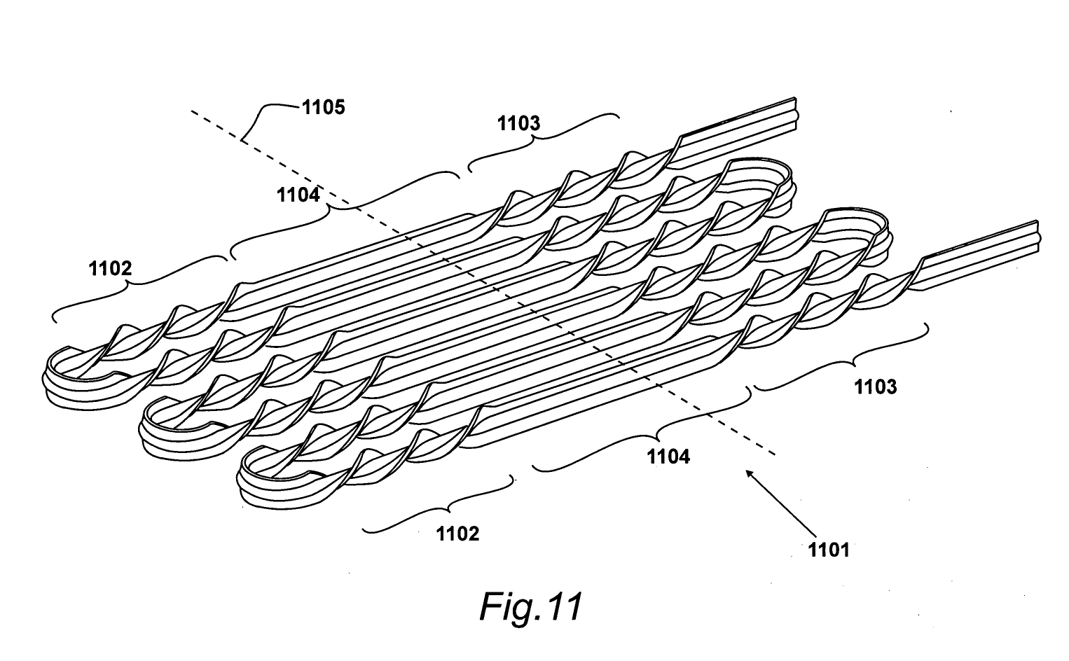

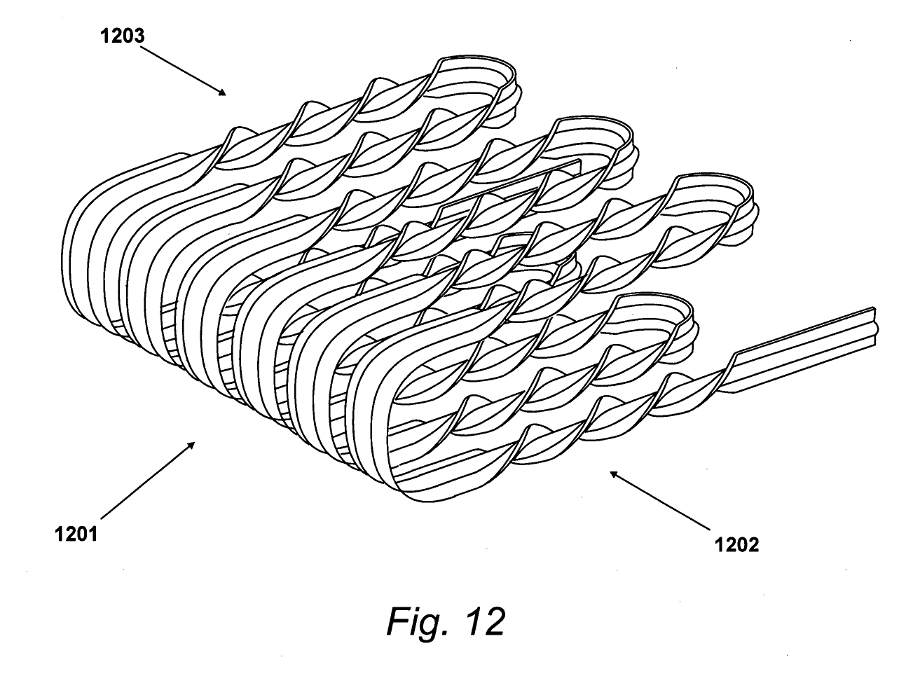

### FIGS. 11 and 12.

In further alternative embodiments the heat transfer tube is formed into a flat meandrous shape which is folded to form a package. A tube 1101 formed into a flat meandrous shape suitable for folding into a package is shown in FIG. 11. The tube 1101 is similar in form to that of FIG. 8, having straight portions that have been twisted such that parts 1102 and 1103 of the straight portions have wing-shaped protrusions formed into a helix. However, a central part 1104 of the straight portions has been left untwisted, that is, the wing-shaped protrusions are planar. Furthermore, each of the wing-shaped protrusions are substantially arranged in a single plane, and consequently the central portion 1104 may be folded about an axis 1105 to form a package.

The package 1201 produced in this way is shown in FIG. 12. The package 1201 comprises a single length of heat transfer tubing having two sets of straight portions 1202 and 1203. Each of the straight portions in a set being arranged in a single plane substantially parallel to the plane of the other set.

In the present embodiment, the tube 1101 has straight portions comprising two helical parts 1102 and 1103 separated by a non-twisted part 1104. Other alternative embodiments are envisaged in which a tube is laid flat into a meandrous shape and the straight portions of the tube comprise three or more helical parts separated by non-twisted parts. Thus, the non-twisted parts of the meandrous shape are folded to form a package comprising three or more sets of straight portions, each set being arranged in a single plane substantially parallel to the planes of the other sets.

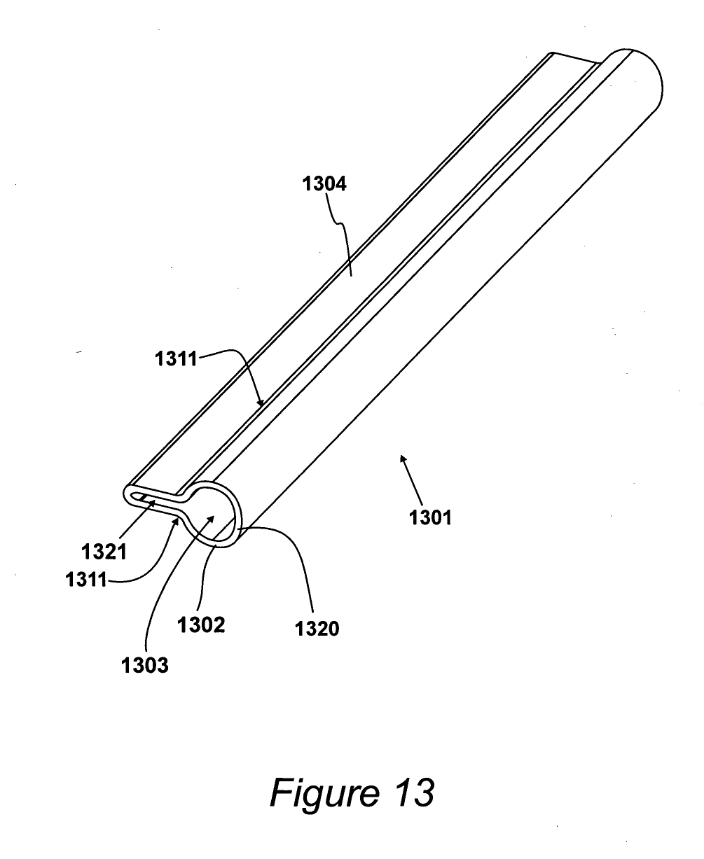

### FIG. 13

Another heat transfer tube 1301 embodying the present invention is shown in FIG. 13. Unlike the previously described heat transfer tubes, the heat transfer tube 1301 has a single wing-shaped protrusion 1304 extending from its main flow portion 1302. Thus, the heat transfer tube 1301 has only two axially extending concave grooves 1311 defining the boundary between the wing-shaped protrusion 1304 and the main flow portion 1302.

Heat transfer tube 1301 is like the heat transfer tube 401 in that the wing-shaped protrusion 1304 contains a gap 1321 that is open to the main bore 1303 of the main flow portion 1302. It will be understood that the heat transfer tube 1301 may be used in a similar way to the heat transfer tubes described above, which have two wing-shaped protrusions. Thus, the heat transfer tube 1301 may be connected to other similar heat transfer tubes in an assembly similar to that of FIG. 5 to produce a heat exchanger.

The tube 1301, like tubes 101 and 401, is formed from a cylindrical tube by deforming the wall of the tube in a press. Thus, the wall 1320 of the tube 1301 contains axially extending folds defining the grooves 1311.

The tube 1301 may also be further processed in a press or by twisting as described above, to provide a wing-shaped protrusion that is non-planar. For example, the heat transfer tube 1301 may be twisted such that the wing-shaped protrusion forms a helix around the main flow portion 1302.

In an alternative embodiment a heat transfer tube similar to heat transfer tube 1301 is formed without a gap within the wing-shaped protrusion.

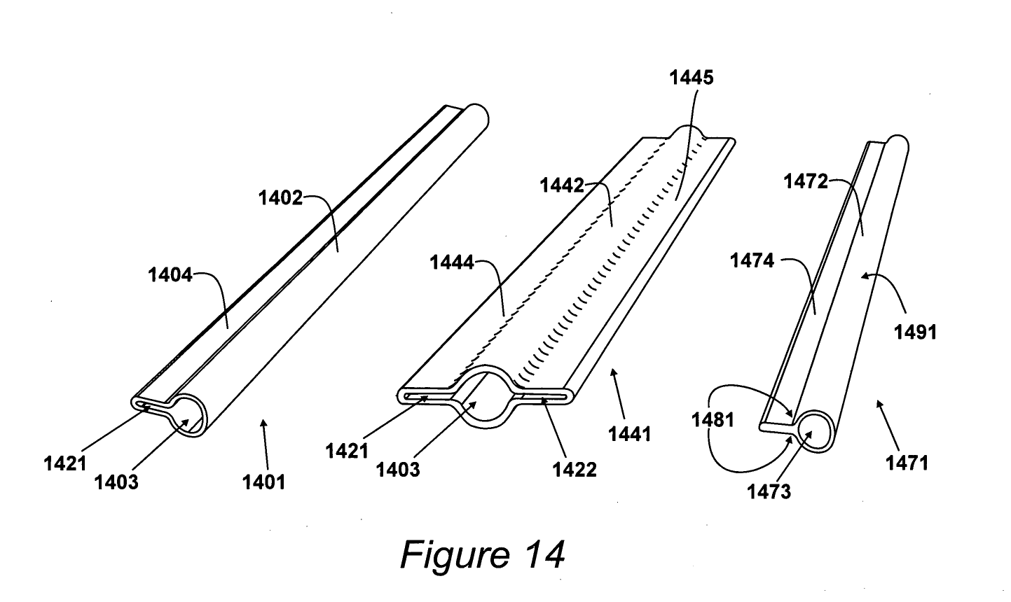

### FIG. 14

Three more heat transfer tubes 1401, 1441 and 1471 for use in heat exchangers are shown in FIG. 14. The three tubes 1401, 1441 and 1471 are each formed by extrusion, an in the present example, each of the tubes 1401, 1441 and 1471 are made from aluminium alloy.

The first heat transfer tube 1401 has a shape substantially the same as tube 1301 of FIG. 13. Thus, it has a single axially extending wing-shaped protrusion 1404, which defines a gap 1421 that is open to the main bore 1403 in the main flow portion 1402 of the tube.

The second heat transfer tube 1441 has a shape substantially the same as tube 401 of FIG. 4. Thus, it has two axially extending wing-shaped protrusions 1444 and 1445. Each of the two protrusions 1444 and 1445 define a gap, 1421 and 1422 respectively, that is open to the main bore 1443 in the main flow portion 1442 of the tube.

It may be noted that both the tube 1401 and the tube 1441 have a wall thickness that is substantially the same all around the tube, in a similar manner to tubes 1301 and 401.

In alternative embodiments to tubes 1401 and 1441, heat transfer tubes are produced by extrusion with more than two axially extending wing-shaped protrusions.

The heat transfer tube 1471 has a single axially extending wing-shaped protrusion 1474, which extends from a main flow portion 1472 of the tube. The main flow portion 1472 has bore 1473, and a convex curved outer surface 1491. Two axially extending concave grooves 1481 exist where the wing-shaped protrusion 1474 meets the main flow portion 1472.

In contrast to previous examples, the wing-shaped, protrusion 1474 is formed as a solid shape, in that it neither contains a gap nor contains inner surfaces that are pressed together (such as in tube 101 of FIG. 1). This is possible due to the fact that the tube 1471 is formed by extrusion.

The main flow portion 1472 of tube 1471 has a substantially cylindrical bore 1473, but other embodiments are envisaged, which have a bore that is non-cylindrical, for example having an oval or polygonal cross-section.

In alternative embodiments to tubes 1471, heat transfer tubes are produced by extrusion with more than one axially extending wing-shaped protrusion that has a substantially solid form, such as that of wing-shaped protrusion 1474.

The wing shaped protrusions of tube 1401, 1441 and 1471 have substantially planar outer surfaces. However, the tubes may be further processed to provide the wing-shaped protrusions with a shape, such as a spiral shape.

1. A heat transfer tube for a heat exchanger, the wall of the heat transfer tube comprising at least one axially extending wing-shaped protrusion to provide the tube with additional heat transfer surface area, wherein the wing shaped protrusion is formed by a process comprising at least one of: (i) folding the wall of the tube; and (ii) extrusion.

2. The heat transfer tube as claimed in claim 1, wherein the wing-shaped protrusion is formed into a non-planar shape.

3. The heat transfer tube as claimed in claim 1, wherein the tube extends along a centre-line and the wing-shaped protrusion forms a spiral around the centre-line of the tube.

4. The heat transfer tube as claimed in claim 1, wherein the tube extends along a centre-line and the wing-shaped protrusion forms a wave shape along the tube.

5. The heat transfer tube as claimed in claim 1, wherein said tube includes two straight portions separated by a curved portion extending around an axis defined by the curvature of the curved portion, and a portion of the wing-shaped protrusion extending along said curved portion extends parallel to said axis.

6. The heat transfer tube as claimed in claim 1, wherein the heat transfer tube is formed into a shape having at least two axially extending wing-shaped protrusions, and the at least two wing-shaped protrusions are equally spaced around the wall of the tube.

7. The heat transfer tube as claimed in claim 1, wherein the heat transfer tube is formed by pressing a length of cylindrical tubing, and said wing-shaped protrusion is formed by folding the wall of the tubing.

8. The heat transfer tube as claimed in claim 7, wherein the wing-shaped protrusion is formed by pressing such that two different portions of the inside surface of the tube are in contact with each other.

9. The heat transfer tube as claimed in claim 1, wherein the heat transfer tube has a main flow portion defining a main bore and the wing-shaped protrusion defines a gap that is open to said main bore.

10. The heat transfer tube as claimed in claim 1, wherein the heat transfer tube is bent into a meandrous shape.

11. The heat transfer tube as claimed in claim 1, wherein the heat transfer tube is bentinto a flat meandrous shape, folded to form a package.

12. The heat transfer tube as claimed in claim 1 formed from a material selected from the group: steel; steel alloy; copper; copper alloy; aluminium; and aluminium alloy.

13. A heat exchanger formed of heat transfer tube in accordance with claim 1.

14. A heat exchanger assembled from a plurality of heat transfer tubes, wherein each said heat transfer tube is as claimed in claim 1, and a pair of said heat transfer tubes are connected by a further tube having a substantially circular cross-section.

15. A heat exchanger as claimed in claim 14, wherein said further tube is formed into a bend and each tube within said pair of heat transfer tubes is substantially parallel to the other tube in said pair.

16. A method of manufacturing a heat transfer tube comprising:
obtaining a length of cylindrical tubing; and
pressing said tubing to fold said tubing into a shape comprising at least one axially extending wing-shaped protrusion to provide a tube with an increased heat transfer surface area.

17. A method of manufacturing a heat transfer tube comprising:
obtaining a material capable of being extruded; and
extruding said material to form tubing having a shape comprising at least one axially extending wing-shaped protrusion to provide a tube with an increased heat transfer surface area.
